(19) United States
(12) Patent Application Publication
(10) Pub. No.: US 2026/0024275 A1
(43) Pub. Date: Jan. 22, 2026

(54) METHOD AND SYSTEM FOR LEARNING SCENE RECONSTRUCTION FROM GATED VIDEOS

(71) Applicant: Torc Robotics, Inc., Blacksburg, VA (US)

(72) Inventors: Felix Heide, New York City, NY (US); Mario Bijelic, Frankfurt (DE)

(21) Appl. No.: 18/780,065

(22) Filed: Jul. 22, 2024

(51) Int. Cl. G06T 15/50; G06T 15/80

(52) U.S. Cl. CPC G06T 15/506; G06T 15/80

(57) ABSTRACT

The application generally relates to a computing system including at least one processor. The at least one processor is configured to execute instructions stored in at least one memory to: initiate emission of a light pulse by an illuminator, after a predetermined delay from emission of the light pulse, initiate capturing of a plurality of pixels in a scene using a plurality of sensors based on the plurality of captured pixels, for a point in the scene, compute a respective value for volumetric density, normal, reflectance and ambient light using a corresponding neural field. The processor further, based upon the emitted light pulse, computes a shadow component corresponding to an origin of the illuminator and a direction of the emitted light pulse and using the computed respective value for volumetric density, normal, reflectance and ambient light and the computed shadow component, constructs a gated image through a volume rendering formulation.

### TECHNICAL FIELD

The field of the disclosure relates generally to autonomous vehicles and, more specifically, to systems and methods for learning scene reconstruction from gated videos.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Large-scale outdoor scene reconstruction is essential for advancing autonomous robotics, drones, and driver-assistance systems, serving as the foundation for scene understanding, safe navigation, dataset generation and validation. Reconstructing outdoor 3D scenes from temporal observations is a challenging task. Existing methods that recover scene properties, such as geometry, appearance, or radiance, solely from RGB captures often fail when handling poorly lit or texture-deficient regions. Similarly, recovering scenes with scanning lidar sensors is also difficult due to their low angular sampling rate that makes recovering expansive real-world scenes difficult.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a computing system including a plurality of sensors, an illuminator, at least one memory storing instructions, and at least one processor in communication with the at least one memory is provided. The at least one processor is configured to execute the stored instructions to: (i) initiate emission of a light pulse by the illuminator, the illuminator has an associated illuminator profile including a plurality of learnable parameters; (ii) after a predetermined delay from emission of the light pulse, initiate capturing of a plurality of pixels in a scene using the plurality of sensors; (iii) based on the plurality of captured pixels, for a point in the scene, compute a respective value for volumetric density, normal, reflectance and ambient light using a corresponding neural field; (iv) based upon the emitted light pulse, compute a shadow component corresponding to an origin of the illuminator and a direction of the emitted light pulse; and (v) using the computed respective value for volumetric density, normal, reflectance and ambient light and the computed shadow component, construct a gated image through a volume rendering formulation.

In another aspect, a vehicle including a plurality of sensors, an illuminator, at least one memory storing instructions, and at least one processor in communication with the at least one memory is provided. The at least one processor is configured to execute the stored instructions to: (i) initiate emission of a light pulse by the illuminator, the illuminator has an associated illuminator profile including a plurality of learnable parameters; (ii) after a predetermined delay from emission of the light pulse, initiate capturing of a plurality of pixels in a scene using the plurality of sensors; (iii) based on the plurality of captured pixels, for a point in the scene, compute a respective value for volumetric density, normal, reflectance and ambient light using a corresponding neural field; (iv) based upon the emitted light pulse, compute a shadow component corresponding to an origin of the illuminator and a direction of the emitted light pulse; and (v) using the computed respective value for volumetric density, normal, reflectance and ambient light and the computed shadow component, construct a gated image through a volume rendering formulation.

In yet another aspect, a computer-implemented method is provided. The computer-implemented method includes (i) initiating emission of a light pulse by an illuminator, the illuminator has an associated illuminator profile including a plurality of learnable parameters; (ii) after a predetermined delay from emission of the light pulse, initiating capturing of a plurality of pixels in a scene using a plurality of sensors, wherein the plurality of sensors includes stereo gated cameras or stereo RGB cameras; (iii) based on the plurality of captured pixels, for a point in the scene, computing a respective value for volumetric density, normal, reflectance and ambient light using a corresponding neural field; (iv) based upon the emitted light pulse, computing a shadow component corresponding to an origin of the illuminator and a direction of the emitted light pulse; and (v) using the computed respective value for volumetric density, normal, reflectance and ambient light and the computed shadow component, constructing a gated image through a volume rendering formulation.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The patent or application file contains at least one drawing executed in color. Copies of this patent or patent application publication with color drawings will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is an illustration of an example reconstruction of a scene representation and rendering depth projections and recovering three-dimensional (3D) geometry and normals;

FIG. 5 is an illustration of an example gated image formation and dual-directional sampling;

FIG. 6 is an example functional block diagram of neural gated fields;

FIG. 7A is an illustration of an example test fixture;

FIG. 7B is an illustration of example views of captures from a dataset collected using the test fixture shown in FIG. 7A;

FIG. 8 is an example table showing comparison of a gated imaging method with the state-of-the-art approaches on depth synthesis;

FIG. 9 is an example illustration of qualitative comparison of state-of-the-art depth estimation approaches with the gated fields methods described herein according to some embodiments;

FIG. 10 is an example table showing comparison of gated fields and state-of-the-art scene reconstruction methods based on evaluation of 3D occupancy reconstruction;

FIG. 11 is an example table showing results of an ablation study; and

FIG. 12 is a flow-chart of method operations for reconstruction of a scene representation and rendering depth projections and recovering three-dimensional (3D) geometry and normal using the gated field described herein according to some embodiments.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Various embodiments described herein correspond with systems and methods for gated fields, which is a neural network based scene reconstruction method that utilizes active gated video sequences. A neural rendering approach described herein seamlessly incorporates time-gated capture and illumination and exploits the intrinsic depth cues in the gated videos for achieving precise and dense geometry reconstruction irrespective of ambient illumination or lighting conditions. When the gated fields method, as described in the present disclosure, is validated across day and night scenarios, the gated fields method is found to be a favorable reconstruction method compared to red-green-blue (RGB) and light detection and ranging (LiDAR) reconstruction methods.

Conventional reconstruction methods have a two-step approach in which depth maps are inferred from different poses utilizing time-of-flight sensors or RGB captures followed by fusing these depth estimations (i.e., the inferred depth maps) to produce a coherent 3D representation. The coherent 3D representation is produced using either classical methodologies or learned-based representation. Additionally, or alternatively, local depth maps' estimation is bypassed as an intermediate representation, and directly regressing a truncated signed distance function (TSDF) or an occupancy volume. Further, neural network based rendering offers geometrically accurate scene reconstruction from posed RGB images and also generates novel perspectives from unobserved angles. RGB-based methods are adapted to large open outdoor environments based on implicit coordinate-based neural representations, and LiDAR scans are used for auxiliary depth supervision and to improve scene reconstruction for urban environments. However, recovery based on the RGB images is fundamentally limited in the presence of low light or in the presence of scattering such as fog.

Similarly, neural network based rendering techniques tailored to time-of-flight sensors, as opposed to the RGB cameras, struggle with recovering large unbounded outdoor scenes. For example, scene understanding with posed LiDAR scans, and based on the raw output modeled from a single-photon LiDAR system or continuous-wave time-of-flight sensor, additional depth supervision may be performed, but struggle with recovering large unbounded outdoor scenes. Additional drawbacks include, but not limited to only being, signal presence or availability from continuous-wave time-of-flight sensors in room-sized scenes, and low angular sampling requiring temporal aggregation for scanning LiDAR. Further, LiDAR sensors, with about 200 scan lines, lag drastically in resolution compared to some known high dynamic range (HDR) cameras offering two orders of magnitude higher vertical pixel counts about 10k and three orders of magnitude higher total resolution.

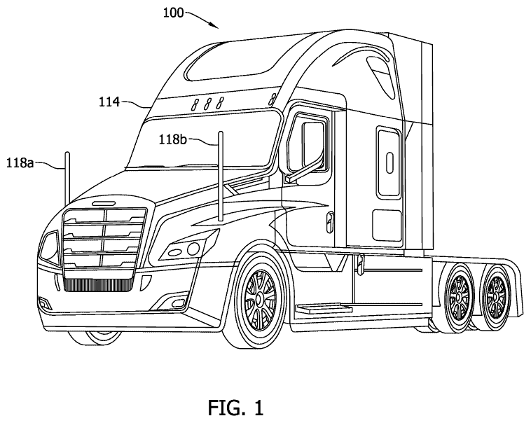

In some embodiments, the above-listed issues or drawbacks of the known systems and methods are resolved using active gated imaging based scene reconstruction, as described in more detail in the present disclosure, using FIGS. 1-12 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

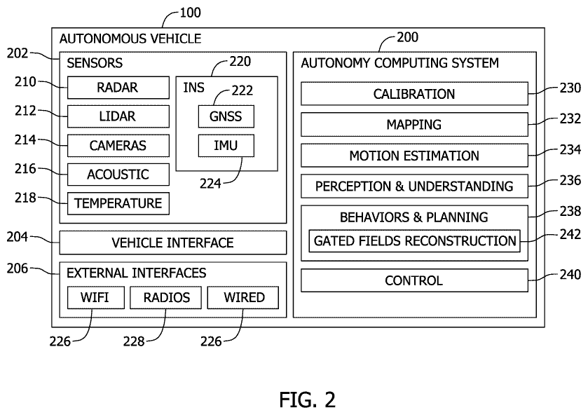

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed for 3D objects detection in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination in perception technologies of autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, 6G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a gated fields reconstruction module 242. The gated fields reconstruction module 242, for example, may be embodied within another module, such as behaviors and planning module 238, or perception and understanding module 236, or separately. These modules may be implemented in dedicated hardware such as, for example, an application specific integrated circuit (ASIC), field programmable gate array (FPGA), a digital signal processor (DSP), or microprocessor, or implemented as executable software modules, or firmware, written to memory and executed on one or more processors onboard autonomous vehicle 100.

The gated fields reconstruction module 242 may perform one or more tasks including, but not limited to, reconstructing a scene utilizing active gated video sequences and seamlessly incorporating time-gated capture and illumination and exploiting the intrinsic depth cues in the gated videos for achieving precise and dense geometry reconstruction irrespective of ambient illumination or lighting conditions.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

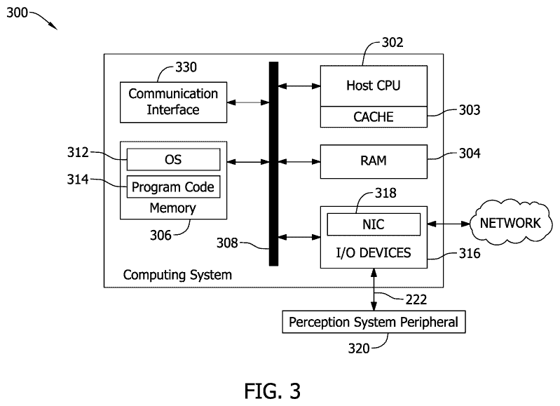

FIG. 3 is a block diagram of an example computing system 300, such as an application server at a hub. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, one or more weight sensors, a keyboard, or a display device, etc.

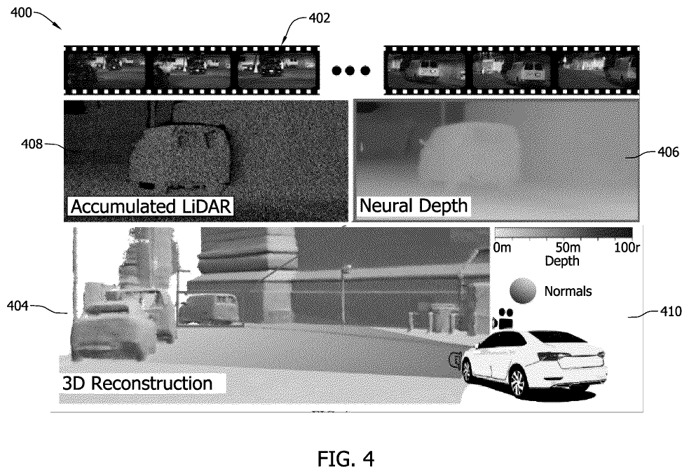

In some embodiments, gated imaging functions include integrating the transient response from a scene that has been flash-illuminated by a synchronized light source. This imaging technique is robust to adverse weather conditions as temporal gating allows to filter out backscatter and provides signal in poorly lit scenes. For state-of-the-art depth estimation and object detection, a neural field-based representation of the scene is trained concurrently learning the scene's geometry, illumination, and material properties by integrating the gated imaging formation model with a neural rendering framework that jointly learns the associated gating parameters along the scene reconstruction. By leveraging the implicit depth cues present in the gated video captures, a detailed 3D geometric model of the scene may be reconstructed, as shown in FIG. 4.

FIG. 4 is an illustration 400 of an example reconstruction of a scene representation and rendering depth projections, and recovering three-dimensional (3D) geometry and normal. As shown in FIG. 4, from a video of gated captures 402 shown in the top-row, an accurate scene representation 404 is reconstructed, and depth projections 406 are rendered. Rendered depth projections 406 are shown in the mid-row on the right. The rendered depth projections 406 are as accurate as LiDAR scans 408, which are shown in the mid-row on the left for comparison, or for reference. 3D geometry 404 and normals 410 recovered from the rendered depth projections 406 are shown in the bottom row.

Compared to LiDAR-based approaches, the gated fields method disclosed herein offers distinct advantages. LiDAR systems are inherently constrained by their resolution, necessitating additional time-multiplexed scene captures to aggregate points, which results in an extended acquisition process for LiDAR-based method or, conversely, compromises the geometric detail of the final estimate. Specifically, for a fixed time acquisition budget the scene reconstruction from a LiDAR sensor is less supervised, although offering highly accurate depth information, the sensor yields data at a volume one order of magnitude less than that of a camera stereo pair. This disparity in data quantity means that while the LiDAR provides precise depth points, it is unable to provide dense and fine detailed predictions.

In some embodiments, the gated fields method may be based upon a captured dataset of varied scenes at day and night conditions, using a vehicle test setup including LiDAR, RGB, and gated sensors. The gated fields method may be compared using feed-forward and 3D reconstruction methods, the gated fields method is found to be superior in depth synthesis over the next best method by up to about 21.87% mean absolute error (MAE), 3D reconstruction improving on the baseline by up to about 11% intersection of union (IoU), and performs view synthesis with a peak signal-to-noise ratio (PSNR) of up to about 32.28 dB.

Accordingly, the present disclosure describes (i) a neural rendering method and scene representation that is capable of reconstructing scene geometry and radiance from active gated camera videos; (ii) modelling the gated image formation process and integrating into differentiable volume rendering to reconstruct and decompose both active and passive light transport components conditioned on the scene parameters in a physically accurate way; (iii) validating the gated fields method on large outdoor scenes captured across various lighting conditions during day and night and achieving a reduction of MAE error in depth precision of up to about 59.8% to the next best RGB+LiDAR method and up to about 31.7% to the next best methods using gated images.

### Monocular and Stereo Depth Estimation

In perception technologies, depth estimation tasks from a single image, stereo image pairs, or single/stereo images with a LiDAR scan are important tasks. Single complementary metal-oxide semiconductor (CMOS) sensor-based depth estimation from RGB color images is limited by scale ambiguity. Additional measurements from LiDAR or ego-vehicle (a vehicle equipped with a test fixture) speed can resolve the scale ambiguity at the cost of an additional sensor. Stereo methods rely on an additional camera sensor to resolve scale ambiguity by triangulating between two camera views. Training approaches for learned depth estimation methods using intensity images cover both unsupervised methods, which harness multi-view geometry consistency, and supervised techniques relying primarily on multi-view datasets or time-of-flight captures. LiDAR measurements are proven as a ground-truth signal for depth supervision for several methods mitigating sparsity and range limitations of scanning LiDAR by accumulating scans. However, adverse weather can make LiDAR ground-truth unreliable, and methods that rely on consistency between camera and LiDAR suffer from degradations including scan pattern artifacts and temporal distortions.

### Time-Gated Depth Sensing

Time-of-flight sensors determine depth by emitting light into a scene and calculating the distance based on the round trip time of the light. Successful sensing methods are categorized into three classes: correlation time-of-flight cameras, pulsed time-of-flight sensors, and gated imaging. Correlation time-of-flight sensors estimate depth by continuously flood-illuminating the scene and assessing the phase shift between the emitted and received light. However, the correlation time-of-flight sensors provide high-resolution depth information, which is primarily confined to indoor settings due to their susceptibility to external light interference. Pulsed time-of-flight sensors function by emitting light pulses toward specific scene points and measure the total travel to estimate depth. Emitting collimated light makes this approach of using pulsed time-of-flight sensors robust against ambient illumination and allows for outdoor depth measurements suffers from limited spatial resolution due to specific scanning illumination technique and compromised efficacy in adverse weather conditions (e.g., fog, rain, or snow) due to backscatter. In contrast, gated cameras capture light from a scene over brief intervals, essentially constraining the observable depth to specific range segments. The inherent gating mechanism of these gated cameras offers resistance to backscattering and allows for recovery of detailed depth maps when using a large number of short gates. Additionally, gated depth estimation may be improved with using few gates by adopting Bayesian approaches deep neural networks (NNs), and accurate gated depth estimation may be achieved for dynamic outdoor scenes, even under challenging conditions. In some examples, state-of-the-art results may be obtained with gated stereo using a stereo-gated setup and self-supervision.

### Neural Scene Reconstruction

Amalgamated sets of single-sensor measurements to recover comprehensive scene representations for view generation and depth estimation, with neural radiance field methods, have emerged as a pivotal approach for representing scenes as continuous volumetric fields of radiance. The neural radiance field methods combine scene representation with volumetric rendering as a forward model in a test-time optimization. Further, the scene representation using neural radiance field methods include coordinate-based networks, 3D voxel-grid representation, or hybrid approaches. The scene representation using the neural radiance field methods covers large outdoor scenes and increases efficiency at training and test time. Some other methods use other than radiance-based representation for explicitly learning scene illumination, geometry, and material properties. However, a particular challenge within the field is reconstructing large urban terrains based on imagery captured from vehicles in which a significant portion of the scene is seen from only a narrow range of viewpoints. This issue may be tackled by additional supervision cues from sparse LiDAR, pre-estimated depths, optical flow and semantic segmentation. Additionally, separate from RGB-based approaches, neural reconstruction methods using time-of-flight sensors may be used for learning a neural field from posed LiDAR scans, allowing for synthesis of realistic LiDAR scans from views. The neural reconstruction method may also include the time-resolved photon count acquired a single-photon LiDAR system.

### Gated Imaging Model

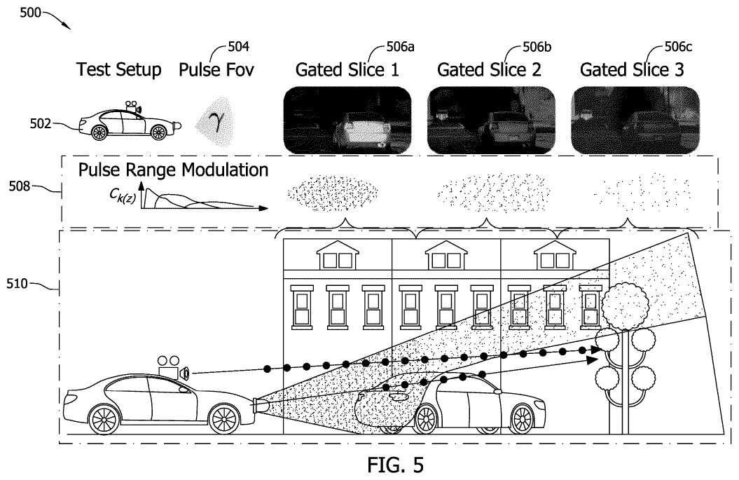

In some embodiments, the gated imaging methods may be used gated image formation model that incorporates shadow effects and self-calibrated parameter learning. The gated imaging system according to some embodiments is illustrated in FIG. 5. FIG. 5 is an illustration of an example gated image formation and dual-directional sampling system 500. A test vehicle 502 is equipped with a synchronized stereo camera setup and an illuminator that flood-lits a scene with a light pulse and a field-of-view (FoV) γ 504. Using different gating profiles c(z), three slices 506a-506c with intensities visualized in red 506a, green 506b and blue 506c. As shown in the middle row in FIG. 5 as 508, the gating profiles describe pixel intensity for a point at sensor distance z. The first slice 506a in red accounts for close ranges, the second slice 506b in green accounts for mid-ranges, and the third slice 506c in blue accounts for far ranges. In the bottom section of FIG. 5, ray sampling as employed in the gated imaging methods described herein is shown as 510. The ray sampling 510 is based on a bidirectional sampling strategy in which rays are casted from the illuminator to explore any occluded areas, while the rays casted from the camera integrate the reflected scene response. The shadowed areas are marked in FIG. 5 in gray.

The gated imaging system, illustrated in FIG. 5 as 500, utilizes a pulsed flood-light illumination source p with a synchronized imager that operates with a nanosecond (ns) gated exposure g that is delayed by ξ compared to the pulse to capture photons with round-trip times inside the gates, hence specific distance segments in the scene. Range intensity profiles Cₖ(2z_{c}) may be used for a given distance z_{c} from the camera, time t, and a parameter set k such that,

$${C}_{k} ( 2 {z}_{C} ) = {\int }_{- ∞}^{∞} {g}_{k} ( t - ξ ) {p}_{k} ( t - \frac{2 {z}_{c}}{C} ) β ( 2 {z}_{C} ) dt , \qquad Eq . l$$

In Eq. 1 above, c is the speed of light and β(⋅) models the distance-dependent decay of the reflected light pulse. The resulting gated pixel value is therefore,

$${I}_{k} ( {z}_{c} ) = {α}_{l} {C}_{k} ( 2 {z}_{c} ) + Λ + {𝒟}_{k} , \qquad Eq . 2$$

In Eq. 2 above, Λ represents the passive ambient contribution, a is the surface reflectance, ₗ represents the laser illumination, and [symbol] ₖ is an additive noise term.

The disclosed gated imaging model assumes a camera position O_{c} and the illuminator position Oᵢ are collocated. For the non-collocated positions of the camera and the illuminator, travel time may be expressed as z=z_{c}+zᵢ, where zᵢ denotes the distance between the illuminator and the point on the surface impacted by the light beam, which is represented as zᵢ=|X−Oᵢ|₂. Additionally, some areas visible to the camera may remain dark due to potential occlusions. Modeling shadow effects and attenuation due to incident angle ω results in the image formation as shown in Eq. 3 below.

$${I}_{k} ( z ) = {α}_{l} ψ \vert n \cdot ω \vert {C}_{k} ( z ) + Λ + {𝒟}_{k} , \qquad Eq . 3$$

In Eq. 3, ψϵ[0,1] serves as a shadow indicator for the pixel, and ω is the direction of the incident light at that point.

When the disclosed gated imaging model is extended to fit the range intensity profiles during optimization, the need for their direct measurement may be eliminated. Additionally, or alternatively, the disclosed gated imaging model may overcome potential calibration inaccuracies encountered in the known approaches. In the gated imaging model described herein, the laser pulse pₖ and the gate gₖ may be modeled as rectangular functions with durations t_{l,k} and t_{g,k}, respectively. Accordingly, analytical computation of the integral in Eq. 1 may be represented as shown in Eq. 4a, Eq. 4b, Eq. 4c, and Eq. 4d below.

$${\tilde{C}}_{k} = \frac{2 z}{C} - {ξ}_{k} + {t}_{l , k} , if {ξ}_{k} - {t}_{l , k} < \frac{2 z}{C} < {ξ}_{k} , \qquad Eq , 4 a$$

$${\tilde{C}}_{k} = {t}_{l , k} , if {ξ}_{k} < \frac{2 z}{C} < {ξ}_{k} + {t}_{g , k} - {t}_{l , k} , \qquad Eq . 4 b$$

$${\tilde{C}}_{k} = - \frac{2 z}{C} + {ξ}_{k} + {t}_{g , k} , if {ξ}_{k} + {t}_{g , k} - {t}_{l , k} < \frac{2 z}{C} < {ξ}_{k} + {t}_{g , k} , \qquad Eq . 4 c$$

$${\tilde{C}}_{k} = 0 , otherwise , \qquad Eq . 4 d$$

### Gated Field

In some embodiments, a scene may be reconstructed by fitting a neural field representation to gated videos collected from three active gated slices I_{kϵ(1,2,3)} with different gating parameters and one passive slice Iₚ. Active illumination may be modeled by jointly estimating light and material properties, and separately representing the ambient light as a radiance field. The disclosed reconstruction method relies on both photometric reconstruction cues and scene priors, as described in detail below.

### Neutral Gated Fields

In some embodiments, scene properties may be described using two neural fields f_{Gp} and f_{Ga}, respectively representing the ambient light scattered in the scene and reflectance of the scene surfaces, conditional on a spatial embedding χ. Moreover, the laser illumination contribution is represented by a physics-based model, while shadow effects are simulated through ray-tracing using the volumetric density field f_{Gd}.

### Neural Ambient and Reflectance Field

In some embodiments, a scene may be represented as a neural field f_{G}: {X, d, ω}→{σ, α, Λ, n} mapping each point in space X viewed from a direction d and laser direction ω to its volumetric density σ, normal vector n, material reflectance αand the passive component Λ, such that,

$${f}_{G p} = \{ d , χ \} \to \{ Λ \} , Ambient Component \\ {f}_{G n} = \{ x , χ \} \to \{ n \} , Surface Normal \\ {f}_{G α} = \{ d , ω , χ \} \to \{ α \} , Surface Reflectance , and \\ {f}_{G d} = \{ x \} \to \{ σ , χ \} , Volume Density and Embedding$$

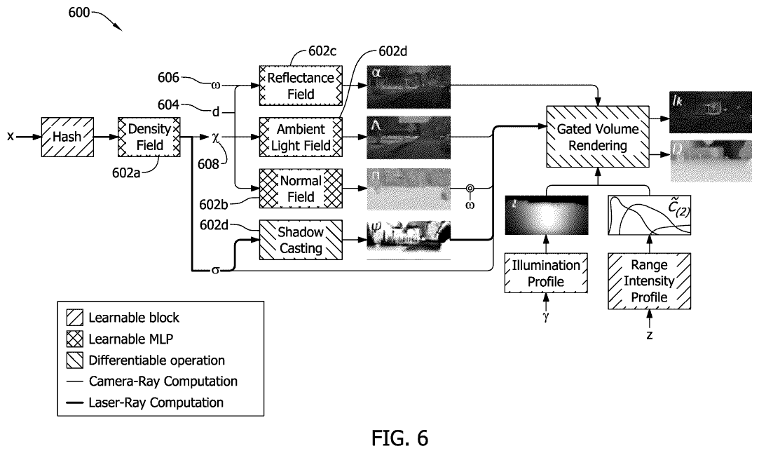

In some embodiments, normal, ambient, and reflectance on a volumetric embedding may be conditioned via the field f_{Gd}={x}→{σ, χ} estimating the density σ and embedding χ. The embedding χ may be shared by network branches to estimate the normal with f_{Gn}={x, χ}→{n}, reflectance f_{Ga}={d, ω, χ}→{α}, and ambient light component with f_{Gp}={d, χ}→{Λ}. An overview of the overall Neural Gated Fields is shown in FIG. 6.

FIG. 6 is an example functional block diagram 600 of neural gated fields. For any point in space x, its volumetric density σ, normal n, reflectance α and ambient lighting Λ through four neural fields 602a, 602b, 602c, and 602d, respectively. The neural fields 602a-602d are conditioned on direction d 604, incident laser light direction ω 606, and spatial embedding χ 608. The illuminator light ₗ is represented by a physics-based model dependent on the displacement angle γ, while the gating imaging process is described by the range intensity profiles c(z) using as input the camera-point-laser distance z, as described herein in for the gated imaging model. A gated image Iₖ through the gated volume rendering formulation using gated field learning described below. The gated field learning is fully differentiable as the neural fields 602a-602d, and physical parameters are simultaneously fitted through image reconstruction together with other regularizations losses as discussed below for training supervision.

In some embodiments, a proposal sampler f_{P} may be used for efficiency. Both f_{G} and f_{P} are a fully connected multi-layer neural network referenced herein as a multilayer perception (MLP). Both f_{G} and f_{P} may be of different sizes with multi-resolution hash encoding.

### Shadow and Illumination Model

As the light pulse emitted by the illuminator is a diverging light beam, it may be modeled as cone of light with irradiance maximum at the cross-section center and exponentially decreasing as it diverges from the center by angles γ. As such, the illumination intensity may be expressed as a 2D higher-order Gaussian ç with mean Ξ, standard deviation Ω, and power Θ as Eq. 5 below.

$$l = {η𝒢}_{i} ( γ , Ξ , Ω , Θ ) \qquad Eq . 5$$

In Eq. 5, η is a scaling parameter.

In some embodiments, instead of predicting the shadow indicator ψ(x), the shadow indicator may be directly estimated using the density field, by computing the accumulated transmittance along the ray from the pixel to the point rᵢₗₗ(l) =Oᵢ+ωl such that

$$ψ ( x ) = exp ( - {\int }_{0}^{lx} σ ( rill ( l ) ) dl ) , \qquad Eq . 6$$

The illuminator origin Oᵢ and direction dᵢ are obtained from the camera as [Oᵢ, dᵢ]=R[O_{c}, d_{c}]+T. During training, T, R and O_{c} are fine-tuned jointly.

In some embodiments, illuminator profile properties η, Ξ, Ω, Θ as well as gating parameters may be treated as learnable parameters. The gating parameters include a number of accumulated laser pulses mₖ before read-out, laser pulse duration t_{l,k}, camera exposure t_{g,k}, and delay ξₖ between laser pulse emission and gated exposure for all three slices k∈{0,1,2}. Additionally, a general distance offset d₀ for the range intensity profiles may be optimized to compensate for internal signal processing delays.

### Gated Field Learning

In some embodiments, a gated capture acquired with camera origin O_{c} and direction d may be learnt by casting a ray r(l)=O_{c}+ld for each pixel into the scene and computing the intensity Ĩₖ(r) through volume rendering. Using the gated imaging formation model described above, volume rendering may be defined as Eq. 7 below:

$${\tilde{I}}_{k} ( r ) = {\int }_{0}^{∞} T ( l ) σ ( x ) {\int }_{- ∞}^{∞} {g}_{k} ( t - {ξ}_{k} ) β ( l ) \cdot ( {α}_{l} ψ \vert n \cdot ω \vert {p}_{k} ( t - \frac{l + {l}_{i}}{c} ) + k ) + dtdl + {𝒟}_{k} , \qquad Eq . 7$$

In Eq. 7 above, k is the ambient level,

$$T ( l ) = exp - ( - {\int }_{0}^{l} σ ( u ) du )$$

is the accumulated transmittance along the ray and lᵢ is the distance of x(l) from the origin Oᵢ. As illustrated in FIG. 5, in the disclosed volume rendering formulation, the pixel intensity contribution of a point along the ray depends not only on its accumulated transmittance and volumetric density, but also on its distance from the illuminator and camera origins through c(z), as well as on its relative position to the illuminator source via ₗ and ψ.

In some embodiments, the time-dependent integral using Eq. 4 above may be simplified as Eq. 8.

$${\tilde{I}}_{k} ( r ) = {\int }_{0}^{∞} T ( l ) σ ( x ) ( α ( X , d , ω ) {\tilde{c}}_{k} ( l + {l}_{i} ) ψ ( x ) \cdot {\vert n \cdot ω \vert}_{l} ( γ ) + Λ ( x , d ) dl + {𝒟}_{k} , \qquad Eq . 8$$

In some embodiments, the spatial integral may be numerically estimated by numerical quadrature, approximating it with a set of points X_{ray}. Specifically, for each point xⱼ∈X_{ray}, the neural field f_{G} may be queried to infer the normal vector nⱼ, reflectance αⱼ, volumetric density σⱼ, and ambient light component Λⱼ. The laser illumination intensity ₗⱼ is instead computed following the physics-based model defined in Eq. 5. The gated intensity Ĩₖ is then expressed using Eq. 9 and Eq. 10 below.

$${\tilde{I}}_{k} ( r ) = {\sum }_{j = 0}^{N} {w}_{j} ( {α}_{j} \tilde{{c}_{J}} {ψ}_{j} {\vert {n}_{j} \cdot {ω}_{j} \vert}_{lj} + {Λ}_{j} ) + {𝒟}_{k} , \qquad Eq . 9$$

$${ω}_{j} = exp ( - {\sum }_{k = 1}^{j - 1} {σ}_{k} {δ}_{k} ) ( 1 - exp ( - {σ}_{j} {δ}_{j} ) ) , \qquad Eq . 10$$

The shadow indicator ψⱼ from Eq. 6 may be similarly approximated by sampling on rᵢₗₗ=Oᵢ+ωⱼl and a set of points Xᵢₗₗ bounded between Oᵢ and xⱼ, accordingly,

$${ψ}_{j} = exp ( - {\sum }_{k}^{X i l l} {σ}_{k} {δ}_{k} ) , \qquad Eq . 11$$

For the passive slice, the active component is null, which further simplifies to Eq. 12 as,

$${\tilde{I}}_{P} ( r ) = {\sum }_{j = 0}^{N} {w}_{j} Λj + {𝒟}_{P} , \qquad Eq . 12$$

Both X_{ray} and Xᵢₗₗ are sampled using a neural network field fₚ that is analogous to f_{Gd} and predicts point-wise densities converted with Eq. 10 to weights ŵ for sampling with piece-wise-constant probabilities.

### Training Supervision

In some embodiments, the passive and active gated frames prediction may be supervised with a photometric loss [symbol] _{c}, regularize the volumetric density with a depth loss [symbol] _{d} and by supervising the shadow estimate with [symbol] ₛ. Normal and reflectance estimates may be regularized through [symbol] _{nc} and [symbol] _{α}, respectively.

In some embodiments, photometric loss may be determined by supervising ground-truth captures for active and passive gated slice reconstruction as Eq. 13a and Eq. 13b.

$${ℒ}_{c A} = {\sum }_{k , r} {‖ {\tilde{I}}_{k} ( r ) - {I}_{k} ( r ) ‖}_{2} , \qquad Eq . 13 a$$

$${ℒ}_{cP} = {\sum }_{r} {‖ {\tilde{I}}_{P} ( r ) - {I}_{P} ( r ) ‖}_{2} , \qquad Eq . 13 b$$

Further, volume density regularization, as additional training supervision, may use depth estimate \hat{D}(r) of a pretrained stereo depth estimation algorithm as pseudo ground-truth to regularize the ray termination distribution as Eq. 14.

$${ℒ}_{d} = {\sum }_{r} {\sum }_{j} log {ω}_{j} exp ( - \frac{{( {l}_{j} - \hat{D} ( r ) )}^{2}}{2 {s}^{2}} ) {δ}_{i} , \qquad Eq . 14$$

The density field may be regularized by partially supervising the shadow indicator ψ. Each pixel whose active intensity I_{kA}=Iₖ−Iₚ in any of the three gated slices is above a certain threshold ϵᵢ is considered as visible from the illuminator. The expected shadow value may therefore be supervised for rays rᵥ∈{r|∀kϵ{1, 2, 3}: I_{kA}(r)<ϵᵢ} as

$${ℒ}_{s} = {\sum }_{{r}_{v}} {‖ 1 - \int T ( l ) σ ( x ) ψ ( x ) dl ‖}_{2} , \qquad Eq . 15$$

For each sampled point x, a consistency between the predicted normal n and the density gradient

$$\hat{n} ( x ) = - \frac{∇ x}{‖ ∇ x ‖}$$

and normal which are backfacing the camera may be penalized as shown in Eq. 16

$${ℒ}_{n c} = {\sum }_{X} w ( x ) ( {‖ n ( x ) - \hat{n} ( x ) ‖}_{2} + {max ( 0 , \hat{n} ( x ) \cdot d )}^{2} ) , \qquad Eq . 16$$

Further, in some embodiments, to ensure the correct separation between reflectance, illumination and shadow, the predicted reflectance a may be enforced to be spatially consistent within ϵₓ that is,

$${ℒ}_{α} = {\sum }_{X} w ( x ) ( {‖ α ( x , d ) - α ( x + {ϵ}_{x} , d + {ϵ}_{d} ) ‖}_{2} , \qquad Eq . 17$$

An angular noise ϵ_{d} may be include that may be set high at the beginning of the training and then decrease it exponentially. By forcing the reflectance to behave as fully diffuse at the beginning of the training, its effects may be prevented from lighting or shadowing, and thereby improving the disjoint learning of the scene components.

In some embodiments, total training loss may be computed by combining the different losses as shown in Eq. 18 below.

$$ℒ = {λ}_{1 A} {ℒ}_{c A} + {λ}_{1 P} {ℒ}_{c P} + {λ}_{2} {ℒ}_{d} + {λ}_{3} {ℒ}_{s} + {λ}_{4} {ℒ}_{n c} + {λ}_{5} {ℒ}_{α} , \qquad Eq . 18$$

In Eq. 18, λ₁, . . . , λ₅ are hyperparameters.

### Example Setup and Implementation Details

In some embodiments, training dataset may be based upon 35000 steps and batch size of 4096 rays. The neural network may be trained using a stochastic optimization method that modifies the typical implementation of weight decay in an adaptive learning rate optimization algorithm that utilizes both momentum and scaling and referenced herein as ADAMW. The protocol using the ADAMW may have β₁=0.9, β₂=0.999, and learning rate of 10⁻² for laser profile and gated parameters. The neural network or neural field fₚ may include two trained MLPs.

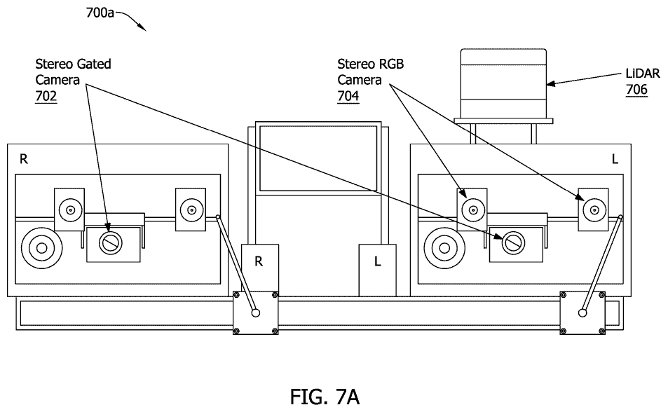

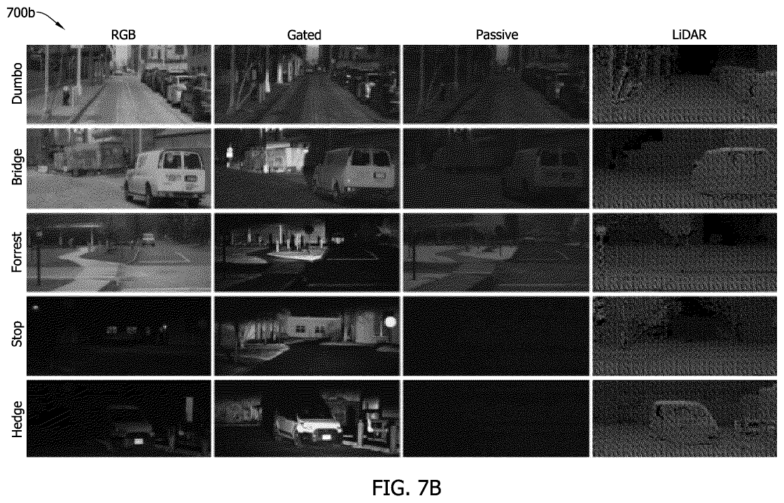

In some embodiments, the dataset used for training the neural network may include a diverse set of 10 static sequences, which are recorded in both day and night conditions. A test vehicle (or an ego vehicle) 700a shown in FIG. 7A is equipped with a near-infrared (NIR) gated stereo camera setup 702 (e.g., Bright-Way Vision), an automotive RGB stereo camera 704 (e.g., OnSemi AR0230), a LiDAR sensor 706 (e.g., Velodyne VLS128). Additionally, or alternatively, the test vehicle may also be equipped with a GNSS with IMU (e.g., Xsens MTi-7, not shown in FIG. 7A). Each gated camera has a resolution of 1280×720 pixels, 10 bit depth and runs at 120 Hz, split up to collect the three active and one passive slice. The illuminator source includes two vertical-cavity surface-emitting laser (VCSEL) modules, which illuminate the scene with a laser pulse with duration of 240-370 nanosecond (ns) and wavelength of 808 nanometer (nm). The RGB cameras provide 12 bit HDR images with resolution of 1920×1080 pixels and 30 Hz framerate. The LiDAR has a vertical resolution of 128 lines and 10 Hz framerate, while the GNSS sensor runs at 4 Hz.

FIG. 7B illustrates a view 700b of example captures from the dataset. By way of a non-limiting example, the dataset may include about 2650 samples captured in both day (about 1223 samples) and night (about 1427 samples). The samples in the dataset may be divided into three subsets for training, validation, and testing with a 50-25-25 split.

In some embodiments, as ground-truth, a large-scale ground-truth point cloud may be constructed by aggregating LiDAR scans with tightly coupled LiDAR inertial odometry via smoothing and mapping (LIO-SAM) and removing noisy points. Further, the disclosed gated imaging method for the scene reconstruction during day and night using depth and view synthesis for 2D evaluation and surface reconstruction for the 3D evaluation may be quantitatively and qualitatively validated. By way of a non-limiting example, the disclosed gated imaging method is compared against the state-of-the-art feed-forward depth estimation algorithms and neural scene reconstruction methods. Further, design choices may be validated by conducting ablation experiments.

In some embodiments, the quality of depth synthesis of gated fields for camera poses that are not seen during training may be assessed by using the accumulated and filtered LiDAR point cloud as ground truth. Instead of relying on single LiDAR scans for evaluation, an accumulated LiDAR point cloud as described herein may be used as ground truth, and thereby allowing depth reconstruction up to 160 m to be evaluated accurately and without bias. Additionally, depth evaluation metrics root mean square error (RMSE), MAE, ARD, σ<1.25i, i∈{1, 2, 3}. The disclosed gated imaging method may be compared against 9 feed-forward depth estimation methods, e.g., SimIPU, AdaBins, DPT, DepthFormer and CREStereo for monocular and stereo RGB methods, Gated2Gated and GatedStereo for monocular and stereo gated estimation methods. Additionally, the disclosed gated imaging method may be compared against depths rendered with other neural reconstruction algorithms, using RGB images, LiDAR, RGB+LiDAR, and a varying-appearance method for gated captures.

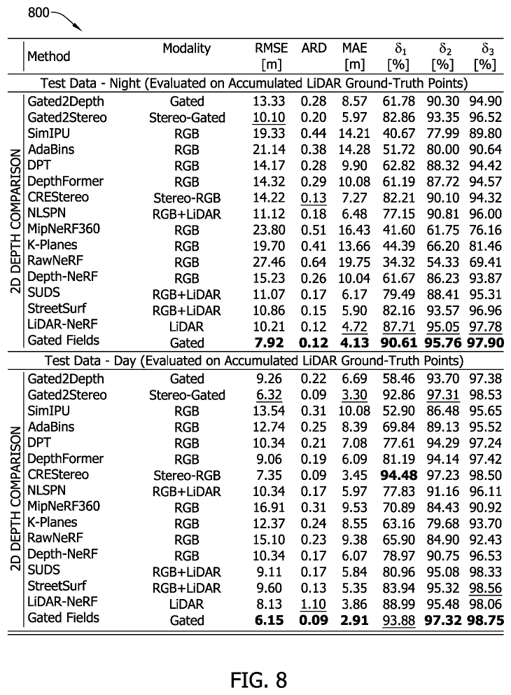

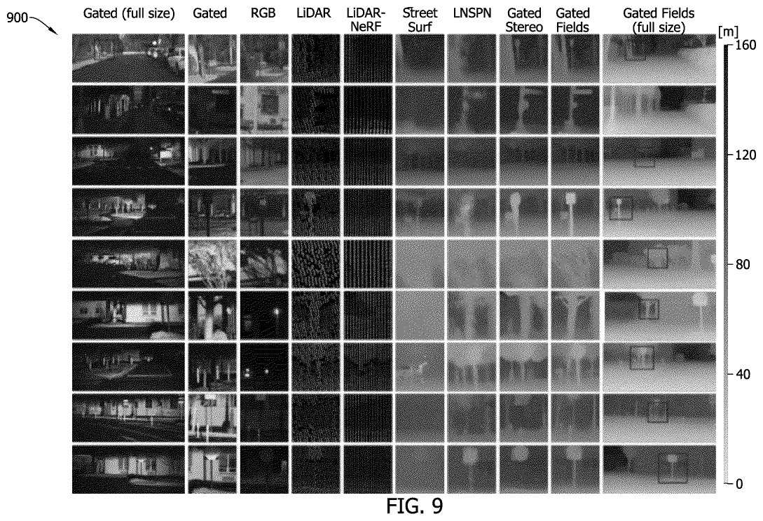

Results may be as shown in an example table 800 in FIG. 8 for comparison of the disclosed gated imaging method with the state-of-the-art approaches on depth synthesis. In the table 800, best results in each category are in bold and second best are underlined. As shown in FIG. 8, the disclosed gated imaging method outperforms the next best neural field method by up to about 21.87% MAE and up to about 30.35% in RMSE. For night sequences, the performance difference sharpens with the disclosed gated imaging method outperforming the best RGB-based method by up to about 3.14 m MAE. The performance decline, however, may be attributed to the limited pixel information present in RGB captures taken at nighttime, making impossible to learn a meaningful 3D representation of the scene, as shown qualitatively in FIG. 9.

FIG. 9 illustrates an example qualitative comparison of the disclosed gated fields herein and state-of-the-art depth estimation approaches including LiDAR-NeRF, StreetSurf, NLSPN, and Gated Stereo. Compared to baseline methods, fine geometry details like branches or poles may be reconstructed from a distance (including a far distance). Unlike RGB methods, gated fields (or a gated imaging method) are not affected by poor ambient lighting, and unlike LiDAR-based methods, sharp object discontinuities may be reconstructed. LiDAR-based methods are unaffected by the charge in illumination but suffer from the limited sensor resolution. On the other hand, gated camera retrieves information- rich captures both during day and night, which gated fields can explicitly leverage during training. Additionally, employing state-of-the-art neural field methods on gated captures does not yield accurate results, as they are not able to model the gated imaging formation and can only fit the ambient light component.

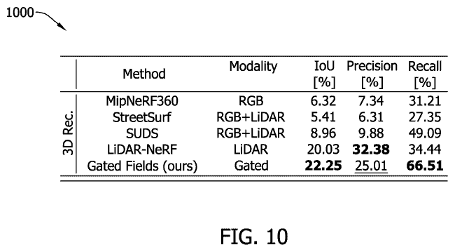

In some embodiments, 3D scene reconstruction capabilities of gated fields may be evaluated using the accumulated LiDAR point cloud as ground truth. A voxelized occupancy grid of the scene may be extracted, and IoU, Precision and Recall between ground truth voxels and estimated one may be computed, for both the 3D ground truth point cloud and different neural field-based methods. Quantitative results may be as shown in an example table 1000 in FIG. 10.

FIG. 10 illustrates an example table 1000 showing comparison of gated fields and state-of-the-art scene reconstruction methods based on evaluation of 3D occupancy reconstruction using the voxelized accumulated LiDAR point cloud as ground truth. In the table 1000, the best results in each category are shown in bold and the second best results are shown as underlined. As shown in the table 1000, the disclosed gated imaging method outperforms RGB baselines by an average of about 15% IoU. While RGB baselines using additional LiDAR sensor data partially improve the results, but such methods are still unable to reconstruct finer surfaces details and struggle at night or in poorly lit conditions. The disclosed gated fields or gated imaging method can recover finer geometries using gated, illumination and depth cues without degrading the quality with diminishing ambient light, as shown in FIG. 9.

In some embodiments, for novel view synthesis, the disclosed gated imaging method may be compared with Mip-NeRF360, a state-of-the-art neural radiance field-based method, and K-Planes, to implicitly model the time-varying appearance of the static scene. Mip-NeRF struggles to reconstruct novel views due to the inherent difficulty of modeling the gating imaging effects, which results in a PSNR of about 17.16 dB. By learning a time-varying appearance, K-Planes improves the quality reaching about 27.42 dB PSNR for day but only improves the quality reaching about 19.35 dB for night, as the model fails to learn an accurate scene geometry representation without ambient light information. The disclosed gated fields or gated imaging method, however, outperforms these baselines in both day and night, reaching a PSNR of about 32.28 dB.

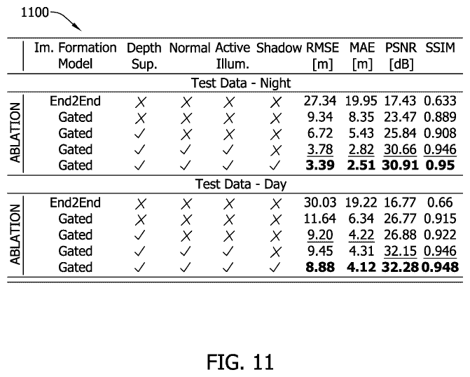

Additionally, or alternatively, a role and contribution of different components of the disclosed gated imaging method may be assessed by performing an ablation study on a subset of the test dataset for investigating different image formation model, neural fields components, and supervision losses. Results of the ablation study may be as shown in an example table 1100 in FIG. 11. In some embodiments, a single neural field directly inferring one intensity value may be considered as a starting point for each of the three active slices and one passive slice. An average MAE of about 19.58 m may be obtained. By separately predicting ambient light and reflectance, and reconstructing the gated image using Eq. 2, the MAE may be substantially improved up to about 7.34 m. However, this approach may perform poorly on flat-color areas during the day and in unilluminated areas during the night due to lack of any depth cue. By adding the depth supervision, such areas may be supervised and PSNR may be improved by up to about 4.83 dB. Further, by adding the angular-dependent attenuation and regularizing the reflectance in Eq. 17, material properties may be disentangled from other spurious effects. Additionally, by explicitly modeling the shadow cast by the illuminator, the final depth reconstruction may be improved up to about 3.32 m MAE.

In summary, the disclosed gated fields or neural rendering method is capable of reconstructing scene geometry from video captures of active time-gated cameras, and hinges on a differentiable gated image formation as part of the rendering formulation while jointly learning geometry, ambient light, and surface properties, which are represented implicitly as neural field components alongside illumination and gating parameters represented with physics-based models. Additionally, using the disclosed gated fields or neural rendering method, a 3D scene both in day and night-time conditions may be precisely reconstructed, with up to about 21.87% on MAE improvement over existing RGB and LiDAR methods and up to about 31.67% on MAE improvement over baseline methods using gated captures. In some embodiments, the disclosed gated fields or neural rendering method may be further improved by providing dynamic feedback to the gated acquisition for allowing adaptive gated scene reconstruction.

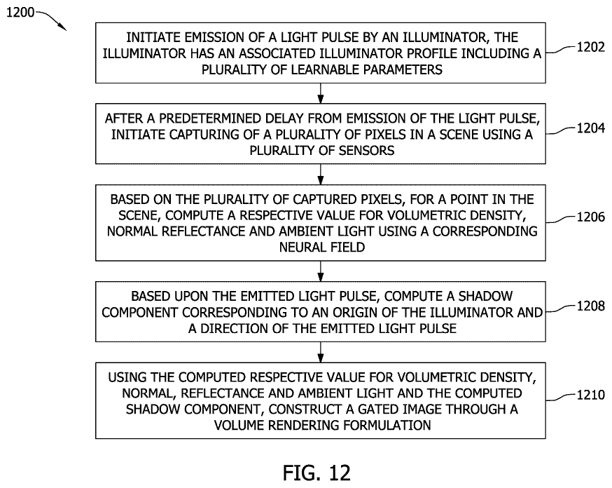

FIG. 12 illustrates an exemplary flow-chart 1200 of method operations performed by an autonomy computing system 200 or a computing system 300 for reconstruction of a scene representation and rendering depth projections and recovering three-dimensional (3D) geometry and normal using the gated field described herein according to some embodiments. The method operations may include initiating 1202 emission of a light pulse by an illuminator. The illuminator may have an associated illuminator profile and the illuminator may emit a light pulse according to the associated profile. Further, the illuminator profile may include a plurality of learnable or optimizable parameters. The illuminator may include a plurality of vertical-cavity surface-emitting laser (VCSEL) modules for illuminating the scene. By way of a non-limiting example, the light pulse is a laser pulse with a duration of 240-370 nanoseconds and a wavelength of 808 nm.

The method operations may include initiating 1204 capturing of a plurality of pixels in a scene using a plurality of sensors. The capturing of the plurality of pixels may be performed after a predetermined delay from emission 1202 of the light pulse. The plurality of sensors may include stereo gated cameras or stereo RGB cameras. Further, the method operations may include based on the plurality of captured pixels, for a point in the scene, computing 1206 a respective value for volumetric density, normal, reflectance and ambient light using a corresponding neural field. In some embodiments, and by way of a non-limiting example, the volumetric density may be normalized with a depth loss. Additionally, or alternatively, each of the normal, reflectance and ambient light may be regularized or normalized with a respective loss component.

The method operations may include based upon the emitted light pulse, computing 1208 a shadow component corresponding to an origin of the illuminator and a direction of the emitted light pulse, as described in more detail in the present disclosure, and constructing 1210 a gated image through a volume rendering formulation using the computed respective value for volumetric density, normal, reflectance and ambient light and the computed shadow component. By way of a non-limiting example, the volume rendering formulation may include computing pixel intensity contribution of the point along a ray of the emitted light pulse based at least in part upon accumulated transmittance through the capturing and the respective value for the volumetric density. Additionally, or alternatively, the volume rendering formulation may include computing pixel intensity contribution of the point along a ray of the emitted light pulse based at least in part upon a distance and a relative position of the point corresponding to the illuminator.

Various functional operations of the embodiments described herein may be implemented using machine learning algorithms, and performed by one or more local or remote processors, transceivers, servers, and/or sensors, and/or via computer-executable instructions stored on non-transitory computer-readable media or medium.

In some embodiments, the machine learning algorithms may be implemented, such that a computer system “learns” to analyze, organize, and/or process data without being explicitly programmed. Machine learning may be implemented through machine learning methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing clement may be trained by providing it with a large sample of images with known characteristics or features or with a large sample of other data with known characteristics or features. Such information may include, for example, information associated with a plurality of images and/or other data of a plurality of different objects, items, or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

In some embodiments, various functional operations of the embodiments described herein may be implemented using an artificial neural network model. The artificial neural network may include multiple layers of neurons, including an input layer, one or more hidden layers, and an output layer. Each layer may include any number of neurons. It should be understood that neural networks of a different structure and configuration may be used to achieve the methods and systems described herein.

In the exemplary embodiment, the input layer may receive different input data. For example, the input layer includes a first input a₁ representing training images, a second input a₂ representing patterns identified in the training images, a third input a₃ representing edges of the training images, and so on. The input layer may include thousands or more inputs. In some embodiments, the number of elements used by the neural network model changes during the training process, and some neurons are bypassed or ignored if, for example, during execution of the neural network, they are determined to be of less relevance.

In some embodiments, each neuron in hidden layer(s) may process one or more inputs from the input layer, and/or one or more outputs from neurons in one of the previous hidden layers, to generate a decision or output. The output layer includes one or more outputs each indicating a label, confidence factor, weight describing the inputs, an output image, or a point cloud. In some embodiments, however, outputs of the neural network model may be obtained from a hidden layers in addition to, or in place of, output(s) from the output layer(s).

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In some embodiments, the layers may not be clearly delineated in terms of the functionality they perform. For example, two or more of hidden layers may share decisions relating to labeling, with no single layer making an independent decision as to labeling.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing system, comprising:
a plurality of sensors;
an illuminator;
at least one memory storing instructions; and
at least one processor in communication with the at least one memory, wherein the at least one processor is configured to execute the stored instructions to:
initiate emission of a light pulse by the illuminator, the illuminator has an associated illuminator profile including a plurality of learnable parameters;
after a predetermined delay from emission of the light pulse, initiate capturing of a plurality of pixels in a scene using the plurality of sensors;
based on the plurality of captured pixels, for a point in the scene, compute a respective value for volumetric density, normal, reflectance and ambient light using a corresponding neural field;
based upon the emitted light pulse, compute a shadow component corresponding to an origin of the illuminator and a direction of the emitted light pulse; and
using the computed respective value for volumetric density, normal, reflectance and ambient light and the computed shadow component, construct a gated image through a volume rendering formulation.

2. The computing system of claim 1, wherein the volume rendering formulation comprises computing pixel intensity contribution of the point along a ray of the emitted light pulse based at least in part upon accumulated transmittance through the capturing and the respective value for the volumetric density.

3. The computing system of claim 1, wherein the volume rendering formulation comprises computing pixel intensity contribution of the point along a ray of the emitted light pulse based at least in part upon a distance and a relative position of the point corresponding to the illuminator.

4. The computing system of claim 1, wherein the volumetric density is normalized with a depth loss.

5. The computing system of claim 1, wherein each of the normal, reflectance and ambient light is regularized or normalized with a respective loss component.

6. The computing system of claim 1, wherein the illuminator includes a plurality of vertical-cavity surface-emitting laser (VCSEL) modules for illuminating the scene.

7. The computing system of claim 6, wherein the light pulse is a laser pulse with a duration of 240-370 nanoseconds and a wavelength of 808 nm.

8. The computing system of claim 1, wherein the plurality of sensors includes stereo gated cameras or stereo RGB cameras.

9. A vehicle, comprising:
a plurality of sensors;
an illuminator;
at least one memory storing instructions; and
at least one processor in communication with the at least one memory, wherein the at least one processor is configured to execute the stored instructions to:
initiate emission of a light pulse by the illuminator, the illuminator has an associated illuminator profile including a plurality of learnable parameters;
after a predetermined delay from emission of the light pulse, initiate capturing of a plurality of pixels in a scene using the plurality of sensors;
based on the plurality of captured pixels, for a point in the scene, compute a respective value for volumetric density, normal, reflectance and ambient light using a corresponding neural field;
based upon the emitted light pulse, compute a shadow component corresponding to an origin of the illuminator and a direction of the emitted light pulse; and
using the computed respective value for volumetric density, normal, reflectance and ambient light and the computed shadow component, construct a gated image through a volume rendering formulation.

10. The vehicle of claim 9, wherein the volume rendering formulation comprises computing pixel intensity contribution of the point along a ray of the emitted light pulse based at least in part upon accumulated transmittance through the capturing and the respective value for the volumetric density.

11. The vehicle of claim 9, wherein the volume rendering formulation comprises computing pixel intensity contribution of the point along a ray of the emitted light pulse based at least in part upon a distance and a relative position of the point corresponding to the illuminator.

12. The vehicle of claim 9, wherein the volumetric density is normalized with a depth loss.

13. The vehicle of claim 9, wherein each of the normal, reflectance and ambient light is regularized or normalized with a respective loss component.

14. The vehicle of claim 9, wherein the illuminator includes a plurality of vertical-cavity surface-emitting laser (VCSEL) modules for illuminating the scene.

15. The vehicle of claim 14, wherein the light pulse is a laser pulse with a duration of 240-370 nanoseconds and a wavelength of 808 nm.

16. The vehicle of claim 9, wherein the plurality of sensors includes stereo gated cameras or stereo RGB cameras.

17. A computer-implemented method, comprising:
initiating emission of a light pulse by an illuminator, the illuminator has an associated illuminator profile including a plurality of learnable parameters;
after a predetermined delay from emission of the light pulse, initiating capturing of a plurality of pixels in a scene using a plurality of sensors, wherein the plurality of sensors includes stereo gated cameras or stereo RGB cameras;
based on the plurality of captured pixels, for a point in the scene, computing a respective value for volumetric density, normal, reflectance and ambient light using a corresponding neural field;
based upon the emitted light pulse, computing a shadow component corresponding to an origin of the illuminator and a direction of the emitted light pulse; and
using the computed respective value for volumetric density, normal, reflectance and ambient light and the computed shadow component, constructing a gated image through a volume rendering formulation.

18. The computer-implemented method of claim 17, wherein the volume rendering formulation comprises computing pixel intensity contribution of the point along a ray of the emitted light pulse based at least in part upon accumulated transmittance through the capturing and the respective value for the volumetric density.

19. The computer-implemented method of claim 17, wherein the volume rendering formulation comprises computing pixel intensity contribution of the point along a ray of the emitted light pulse based at least in part upon a distance and a relative position of the point corresponding to the illuminator.

20. The computer-implemented method of claim 17, wherein:
the volumetric density is normalized with a depth loss;
each of the normal, reflectance and ambient light is regularized or normalized with a respective loss component;
the illuminator includes a plurality of vertical-cavity surface-emitting laser (VCSEL) modules for illuminating the scene; or the light pulse is a laser pulse with a duration of 240-370 nanoseconds and a wavelength of 808 nm.
